(19) United States
(12) Patent Application Publication
(10) Pub. No.: US 2002/0074410 A1
(43) Pub. Date: Jun. 20, 2002

(54) Scanning apparatus for barcode device

(76) Inventor: Yu-Chun Chang, Taipei (TW)

Correspondence Address: BACON & THOMAS, 4th Floor, 625 Slaters Lane, Alexandria, VA, 22314, US

(21) Appl. No.: 09/736,219

(22) Filed: Dec. 15, 2000

(51) Int. Cl. G02B 5/08; G02B 26/00; G06K 7/10

(52) U.S. Cl. 235/462.36

(57) ABSTRACT

An improvement of scanning apparatus for barcode device includes a scanning means, a light collection means and a sensor means. The light collection means is located in front of the scanning means. The sensor means is located at the incident angle focus distance of the incident light resulting from the reflection light projecting on the light collection means. The projection light of the scanning means, and the incident light resulting from the light collection means and the sensor means are located at same optical path. Hence there is no angle deviation and may greatly increase barcode reading distance.

### BACKGROUND OF THE INVENTION

This invention relates to improvement of scanning apparatus for barcode device and particularly an improvement that enables projection light, incident light and the sensor means to be located at the same optical path.

The commonly used optical scanning means adapted for barcode reading devices and the method of collecting reflection light and reading barcode can be categorized in two types: one type is to project light on the barcode and directs the lit barcode image passing through a lens to a Charged Couple Device (CCD) which captures the image and converts to electric signals for output; another type is using light spot scanning method in which an oscillation or rotation means projects the scanning light spot on the barcode then the reflected light is collected. As the black and white barcode has black and white color variation, the reflected light has relative different intensity which may be converted to electrical signals through a sensor means. The later method is mostly used in laser type barcode reader.

In the scanning methods set forth above, there are two ways for collecting reflection light. One uses lens to collect and amplify the reflection light, and transmits the collected signals to a sensor element. Another one uses an arched light collection mirror like the one used in radar. Incident light of different angles may be collected and projected to a sensor element located at the focus point. Regardless which way is used, an ideal optical structure arrangement is to put the projection light, incident light and sensor element at the same optical path. The reason is simple, if they are not at the same optical path, the projection light and receiving position will form an angle. When the target (barcode) is located at a distance, the projection light will have a great deviation. At a certain distance, the reflection light will stray away from the detection scope of the sensor element and make reading the barcode not possible.

There are products in the market place that also adapt similar method and design. One of the instances is using an arched mirror as scanning mirror and reflection mirror concurrently. However that kind of design has two disadvantages. First, in order to get better light collection effect, the arched mirror should have a relatively large surface just like radar for collecting electric wave. The size of the arched mirror usually is much larger than the reflection mirror. Consequently, a larger space is needed for accommodating the oscillation of the arched mirror during operation. The larger size also means greater weight and loading. It needs more electric power to drive and operate. Second, The sensor element need cable and wiring which should not be too long in order to prevent the weak signal from interference. Hence it is not advisable to make the sensor element work like in radar in which the collector (equivalent to arched mirror) and antenna (equivalent to sensor element) are moving at the same time. A better design would be to make the sensor element stationary. However if the arched mirror oscillates and the sensor element remains stationary, the ideal focus point of the collected reflection light will be at a spot different from where the sensor element is located.

### SUMMARY OF THE INVENTION

In view of aforesaid disadvantages, it is therefore an object of this invention to provide an improvement of scanning apparatus for barcode device that put projection light, incident light and the sensor element at the same optical path so that there is no angle deviation and barcode reading distance may be greatly increased.

Another object of this invention is to provide a way for designing correct curvature for the light collection element (i.e. arched mirror) through scanning and projecting the projection light at an angle, and deriving the reflection angle and focus distance for the light collection element based on the scanning angle.

In order to achieve aforesaid objects, in this invention a light collection means is located stationary in front of a scanning means, and a sensor means is located at the incident angle focus distance of the incident light resulting from the reflection light projecting on the light collection means, whereby the projection light generated by the scanning means and incident light generated by the light collection means and the sensor means will be confined to the same optical path and thus eliminate angle deviation.

### BRIEF DESCRIPTION OF THE DRAWINGS

The invention, as well as its many advantages, may be further understood by the following detailed description and drawings, in which:

FIG. 1 is a perspective view of this invention.

FIG. 2 is a perspective view of this invention from another angle, according to FIG. 1.

FIG. 3 is a schematic top view of a scanning apparatus of this invention

FIG. 4 is a simplified schematic side view of a scanning apparatus of this invention.

FIG. 5 is a schematic top view of the optical path of this invention.

FIG. 6 is a schematic side view of the optical path of this invention.

### DESCRIPTION OF THE PREFERRED EMBODIMENTS

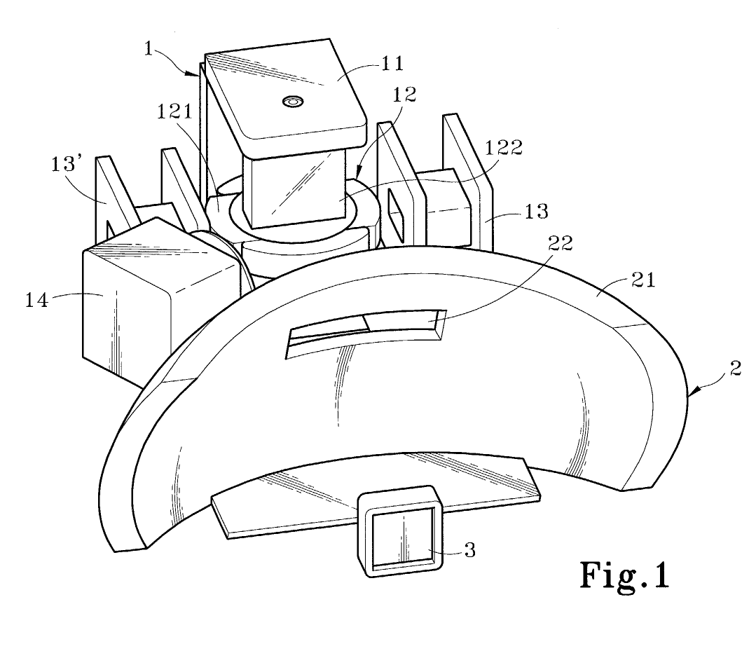

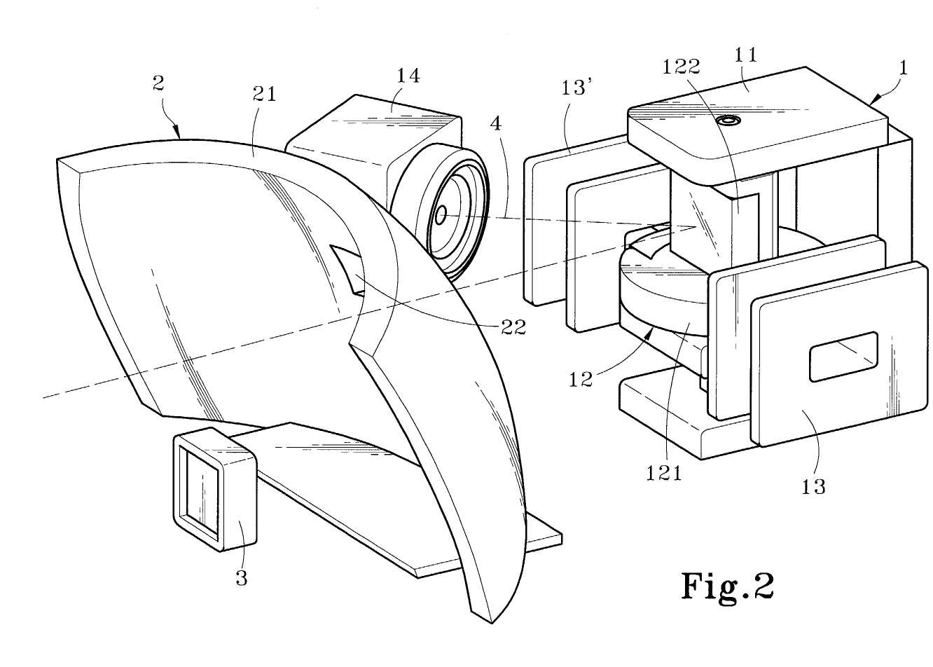

Referring to FIGS. 1 and 2, the scanning apparatus according to this invention includes a scanning means 1, a light collection means 2 located in front of the scanning means 1 in a stationary manner, and a sensor means 3 located at the incident angle focus distance of the incident light resulting from the reflection light projecting on the light collection means 2. The projection light, incident light and sensor means 3 are at the same optical path. Hence there is no angle deviation and may greatly increase barcode reading distance. The scanning means 1 includes a spindle anchor 11, a rotary element 12 pivotally located in the spindle anchor 11, two driving elements 13 and 13′ located at two sides of the spindle anchor 11, and a light source element 14 located at a skew position in front of the spindle anchor 11 and driving element 13′. The rotary element 12 includes a magnetic element 121 and a reflection element 122 which may reflect light to a barcode attached to an object (not shown in the figures). The driving elements 13 and 13′ may be a coil or magnet that is capable of generating magnetic force. The magnetic force generated by the driving elements 13 and 13′ will drive the magnetic element 121 and turn the rotary element 12. The reflection element 122 located on the rotary element 12 will also be turned. Light 4 generated by the light source element 14 (laser diode or light emitting diode) thus may be directed to projecting on the barcode of the object.

The light collection means 2 is located in front of the scanning means 1 at a selected position in stationary manner for collecting barcode image reflected from the object after subject to light projection. The light collection means 2 includes an arch-shaped light collection element 21 which has an opening 22 formed at a selected location therein and allowing the light 4 to pass through. The opening 22 has a sufficient size for containing at least the moving boundary of the light 4 resulting from the turning of the reflection element 122. The opening 22 also allows the projection light, incident light and sensor means 3 to confine at the same optical path.

The sensor means 3 may be, but not limit to, a photo diode, CDS, photo transistor, pin diode, or solar cell. The sensor means 3 is located in front of the light collection means 2 at the focus distance of the incident light 6 which is resulted from the reflection light 5 for receiving and converting the barcode image collected by the light collection means 2 to electric signals. Hence barcode attached to the object may be read and captured.

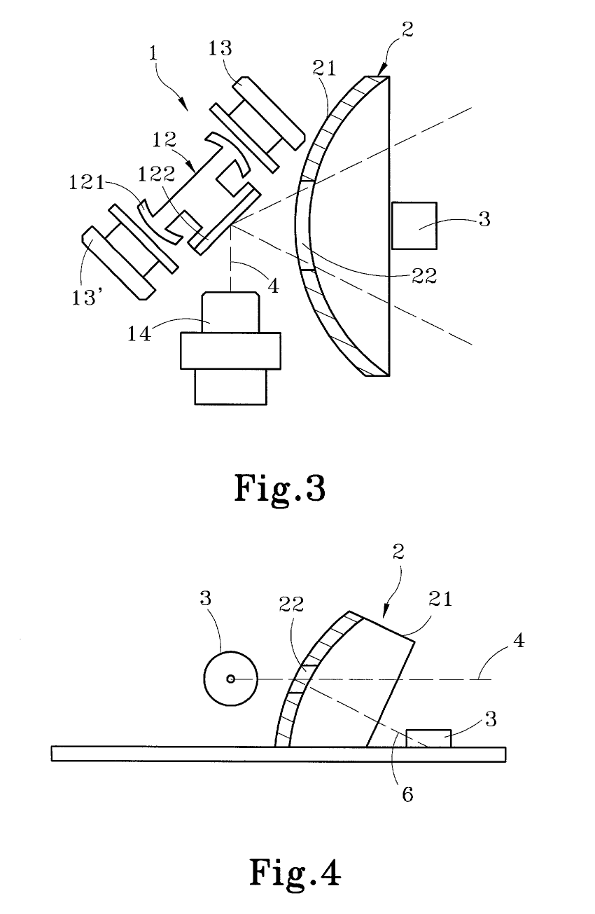

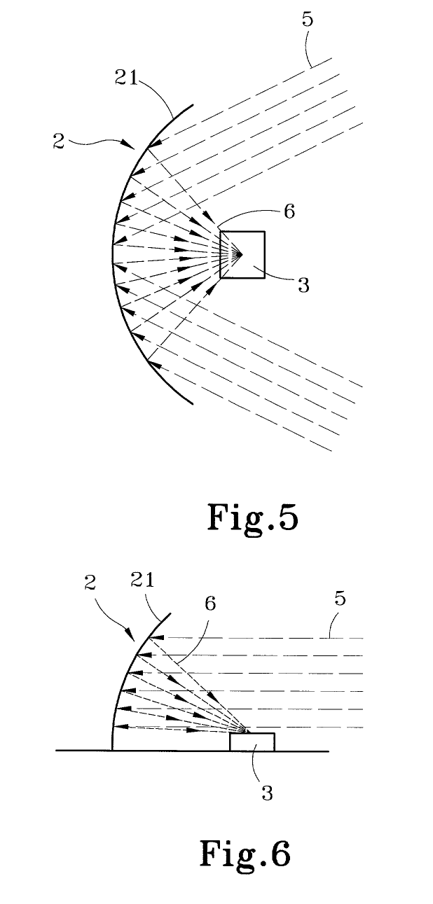

Referring to FIGS. 3 through 6 for the optical path of this invention, the magnetic driving element 13 and 13′ may generate magnetic force to turn the magnetic element 121 which in turn turns the reflection element 122. Light 4 generated by the light source element 14 projects on the reflection element 122 and will be reflected through the opening 22 and projecting upon the barcode (not show) attached to the object (not show). The reflected barcode image light 5 is collected by the light collection element 21. The reflected light becomes incident light 6 and will be projected to the sensor means 3 for converting to electric signals. Thus complete the barcode reading process.

By means of the structure set forth above, the projection light 4, incident light 6 and sensor means 3 are all located at the same optical path. As a result, there is no deviation angle. Barcode reading distance thus may be greatly increased. Other factors that might affect the reading capability will be confined to light source power and focus after light converging.

Furthermore, projection light 4 projects scanning light at an angle which may be used for calculating the reflection angle and focus distance of the light collection element 21, and consequently deriving the correct curvature of the light collection element 21 for making the optimal optical path arrangement.

It may thus be seen that the objects of the present invention set forth herein, as well as those made apparent from the foregoing description, are efficiently attained. While the preferred embodiment of the invention has been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An improvement of scanning apparatus for barcode device for scanning a barcode located on an object, comprising:
a scanning means capable of generating a projection light;
a light collection means located in front of the scanning means for receiving a reflection light and generating an incident light; and
a sensor means located at the incident angle focus distance of the incident light of the light collection means;
wherein the projection light, incident light and the sensor means are located at same optical path for eliminating angle deviation.

2. The improvement of scanning apparatus of claim 1, wherein the scanning means includes a spindle anchor, a rotary element pivotally located in the spindle anchor, two driving elements located at two sides of the spindle anchor, and a light source element located at a skew position in front of the spindle anchor and one driving element.

3. The improvement of scanning apparatus of claim 2, wherein the light source element is selectively a laser diode or a light emitting diode.

4. The improvement of scanning apparatus of claim 2, wherein the rotary element includes a magnetic element and a light reflection element.

5. The improvement of scanning apparatus of claim 2, wherein the driving elements are coils capable of generating magnetic force or magnets.

6. The improvement of scanning apparatus of claim 1, wherein the light collection means includes a arch-shaped light collection element which has an opening formed at a selected location thereof.

7. The improvement of scanning apparatus of claim 6, wherein the opening has a selected size for containing at least the moving boundary of the light reflected by light reflection element to the barcode.

8. The improvement of scanning apparatus of claim 6, wherein the projection light has a scanning projection angle, the curvature of the light collection element is derived through a scanning projection angle of the projection light whereby to calculate reflection angle and the focus distance for designing correct curvature.

9. The improvement of scanning apparatus of claim 1, wherein the sensor means is selected from the group consisting of photo diode, CDS, photo transistor, pin diode, and solar cell.
